(19) United States
(12) Patent Application Publication
(10) Pub. No.: US 2012/0197754 A1
(43) Pub. Date: Aug. 2, 2012

(54) SYSTEMS AND METHODS FOR SHOPPING IN AN ELECTRONIC COMMERCE ENVIRONMENT

(75) Inventor: Robert Kalin, Brooklyn, NY (US)

(73) Assignee: Etsy, Inc., Brooklyn, NY (US)

(21) Appl. No.: 13/015,623

(22) Filed: Jan. 28, 2011

(51) Int. Cl. G06Q 30/00

(52) U.S. Cl. 705/26.8; 705/27.1

(57) ABSTRACT

A method of shopping within an electronic commerce environment includes providing first, second and third user interfaces generated by a server computer system, enabling a user of an electronic commerce website to select an item for sale using the first user interface, providing, to the user, a suggestion for a recipient for the selected item based on a relationship between the user and the suggested recipient, enabling the user to designate the suggested recipient as a prospective recipient of the selected item using the second user interface, and enabling the user to contribute funds toward a purchase of the selected item using the third user interface wherein the selected item is to be shipped to the prospective recipient subsequent to the purchase. The relationship is to be identified using characterization information associated with the user and stored in a database on the server computer system.

### CROSS-REFERENCE TO RELATED APPLICATIONS

This application is related to co-pending U.S. Application Serial No. TBD, entitled “SYSTEMS AND METHODS FOR SHOPPING IN AN ELECTRONIC COMMERCE ENVIRONMENT,” Attorney Docket No. E2017-700519, and filed on Jan. 28, 2011, which is herein incorporated by reference in its entirety.

This application is further related to co-pending U.S. Application Serial No. TBD, entitled “SYSTEMS AND METHODS FOR SHOPPING IN AN ELECTRONIC COMMERCE ENVIRONMENT,” Attorney Docket No. E2017-700619, and filed on Jan. 28, 2011, which is herein incorporated by reference in its entirety.

### BACKGROUND OF THE INVENTION

1. Field of Invention

Embodiments of the present invention relate generally to electronic commerce.

2. Discussion of Related Art

Consumers are increasingly using the Internet to purchase goods and services through electronic commerce (e-commerce) websites, both for their own use and consumption as well as for gifts to others. For example, it is possible to shop for, select and purchase an item online as a gift for a relative, friend, colleague, or other person, particularly those with whom the purchaser has an existing relationship. Some e-commerce websites allow a user to shop and pay for the gift item, and then request that the merchant ship the item directly to the recipient rather than to the purchaser. Additionally, as a gift shopping convenience, some websites allow users to maintain virtual address books containing the names and shipping addresses of various acquaintances. A shopper may use the address book to easily provide the shipping information of the item's intended recipient. These conventional techniques require the shopper to provide the shipping information in advance of, or during, the purchase process. Therefore, selecting gift recipients is largely a manual process.

### BRIEF SUMMARY OF THE INVENTION

It is appreciated that a user engaged in an online shopping process, in accordance with various embodiments of the present disclosure, may be provided with information about other people with whom the user has a relationship or other association. Such relationships may include friends, family members, colleagues, business associates, buyers and sellers, or relationships based on other social commitments. Relationships may also be based on other characteristics, such as people who purchase, sell, or are otherwise interested in similar items (e.g., items that are fabricated using similar techniques, tools or materials), people who live or work in similar geographic locations, and people in similar age or other demographic groups. A relationship may be defined, for example, by associating a characteristic (e.g., friend, colleague, item purchased etc.) with the user in a database maintained in conjunction with an e-commerce website (e.g., on a virtual shopping server).

In one example, when a user selects an item for sale on an e-commerce website, the relationships may be used by the e-commerce system or platform to suggest one or more potential recipients for whom the user may purchase the selected item as a gift. In another example, the relationships may be used to suggest gift items based on characteristics of the related person, such as the person's shopping history or the person's favorite items. The user may designate one or more of the suggested recipients to receive the item as a gift. Further, the user may either purchase the item outright for the designated recipient, or contribute funds toward the purchase of the item. The user may further invite other users to contribute funds toward the purchase of the item. Once sufficient funds have been contributed, the item may be purchased for the designated recipient.

According to one embodiment of the present disclosure, a method of shopping within an electronic commerce environment includes providing first, second and third user interfaces generated by a server computer system, enabling a user of an electronic commerce website to select an item for sale using the first user interface, providing, to the user, a suggestion for a recipient for the selected item based on a relationship between the user and the suggested recipient, enabling the user to designate the suggested recipient as a prospective recipient of the selected item using the second user interface, and enabling the user to contribute funds toward a purchase of the selected item using the third user interface wherein the selected item is to be shipped to the prospective recipient subsequent to the purchase. The relationship is to be identified using characterization information associated with the user and stored in a database on the server computer system.

In another embodiment, the method may further include an act of enabling the user to invite at least one other user to contribute funds toward the purchase of the selected item using a fourth user interface to be provided by the server computer system. In yet another embodiment, the method may further include an act of sending a message to the at least one other user for inviting the at least one other user to contribute funds toward the purchase of the selected item using a fourth user interface to be provided by the server computer system. In yet another embodiment, the method may further include an act of enabling the at least one other user to contribute funds toward the purchase of the selected item using a fourth user interface to be provided by the server computer system. In another embodiment, the purchase may occur when a total of the contributed funds is sufficient to purchase the selected item.

In another embodiment, the method may further include an act of enabling the at least one other user to invite at least one additional user to contribute funds toward the purchase of the selected item using a fourth user interface to be provided by the server computer system. In yet another embodiment, the method may further include an act of enabling the at least one additional user to contribute funds toward the purchase of the selected item using a fourth user interface to be provided by the server computer system.

In various embodiments, the suggested recipient may be a family member of the user, a friend of the user, a friend-of-a-friend of the user, a person from whom the user has previously purchased a commodity, a person to whom the user has previously sold a commodity, a person who designed a commodity purchased by the user, and/or a person who purchased a commodity designed by the user.

In another embodiment, the act of suggesting may further include determining a confidence level associated with the suggested recipient based on a characteristic of the suggested recipient, and wherein the act of suggesting is further based on the confidence level. In yet another embodiment, the characteristic of the suggested recipient may include at least one of favorite items of the suggested recipient and items purchased by the suggested recipient. In yet another embodiment, the act of suggesting may further include an act of ranking the suggested recipient based on the confidence level. In yet another embodiment, the act of suggesting may further include an act of ranking the suggested recipient based on the relationship. In one embodiment, a ranking of the suggested recipient may correspond to a degree of separation between the user and the suggested recipient, wherein the degree of separation accords to one of a familial relationship, a friendship, and an indirect relationship.

According to one embodiment of the present disclosure, an electronic commerce system includes a virtual shopping cart component configured to enable a user to select an item for sale using a first user interface to be provided by a server computer system, and a recipient configuration component. The recipient configuration component is configured to suggest, to the user, a recipient for the selected item based on a relationship between the user and the suggested recipient, enable the user to designate the suggested recipient as a prospective recipient of the selected item using a second user interface to be provided by the server computer system, and enable the user to contribute funds toward a purchase of the selected item using a third user interface to be provided by the server computer system. The relationship is to be identified using characterization information associated with the user and stored in a database to be provided by the server computer system. The selected item is to be shipped to the prospective recipient subsequent to the purchase.

In another embodiment, the recipient configuration component may be further configured to enable the user to invite at least one other user to contribute funds toward the purchase of the selected item using a fourth user interface to be provided by the server computer system. In yet another embodiment, the recipient configuration component may be further configured to send a message to the at least one other user for inviting the at least one other user to contribute funds toward the purchase of the selected item using a fourth user interface to be provided by the server computer system. In yet another embodiment, the recipient configuration component may be further configured to enable the at least one other user to contribute funds toward the purchase of the selected item using a fourth user interface to be provided by the server computer system. In one embodiment, the purchase may occur when a total of the contributed funds is sufficient to purchase the selected item. In another embodiment, the recipient configuration component may be further configured to enable the at least one other user to invite at least one additional user to contribute funds toward the purchase of the selected item. In yet another embodiment, the recipient configuration component may be further configured to enable the at least one additional user to contribute funds toward the purchase of the selected item using a fourth user interface to be provided by the server computer system.

According to one embodiment of the present disclosure, a computer readable readable medium includes computer-executable instructions stored thereon for shopping within an electronic commerce website. The computer-executable instructions, when executed by a computer, cause the computer to perform a method including acts of enabling a user of an electronic commerce website to select an item for sale using a first user interface to be provided by a server computer system, suggesting, to the user, a recipient for the selected item based on a relationship between the user and the suggested recipient, enabling the user to designate the suggested recipient as a prospective recipient of the selected item using a second user interface to be provided by the server computer system, and enabling the user to contribute funds toward a purchase of the selected item using a third user interface to be provided by the server computer system. The relationship is to be identified using characterization information associated with the user and stored in a database to be provided by the server computer system. The selected item is to be shipped to the prospective recipient subsequent to the purchase.

In another embodiment, the method may further comprises acts of generating, by the server computer system, statistical data related to the item, the statistical data including a total quantity of the item that is contained in a plurality of virtual shopping carts of a plurality of users, and providing the statistical data to the first user in a fourth user interface to be provided by the server computer system.

Further embodiments related to the present disclosure will now be described.

According to one embodiment related to the present disclosure, a method of shopping within an electronic commerce environment includes enabling a first user to add one or more items to a virtual shopping cart using a first user interface that is generated by a server computer system, enabling the first user to enter into a commitment to contribute funds toward a purchase, by a second user, of at least one of the items in the virtual shopping cart using a second user interface that is generated by the server computer system, and enabling the second user to purchase the items by exercising the commitment of the first user. The first user may share access to the virtual shopping cart with the second user. The second user may access the virtual shopping cart subsequent to the first user sharing access to the virtual shopping cart with the second user.

According to another embodiment, the contents of the virtual shopping cart may include the items. The second user may modify the contents of the virtual shopping cart using a third user interface that is generated by the server computer system. The first user and/or the second user may be provided with information related to the commitment of the first user through a third user interface that is generated by the server computer system. The information may include an identity of the first user, a first fund amount representing the commitment of the first user, a second fund amount representing a difference between at least a price of items and the first fund amount, or any combination of this information.

In another embodiment, the commitment to contribute funds may include an initial contribution amount. A third user may enter into a commitment to contribute additional funds toward the purchase, by the second user, of the items in the virtual shopping cart using a third user interface that is generated by a server computer system. The second user may purchase the items by exercising the commitment of the third user. The third user may be authorized by the first user to enter into the commitment to contribute additional funds.

According to yet another embodiment, the first user may compose an electronic message to be transmitted to the second user in conjunction with entering into the commitment of the first user.

According to one embodiment, an electronic commerce system includes a server computer system having at least one processor that is configured to execute a plurality of processes. The processes include enabling a first user to create a virtual shopping cart containing one or more items, enabling the first user to enter into a commitment to contribute funds toward a purchase, by a second user, of at least one of the items contained in the virtual shopping cart, and enabling the second user to purchase the items contained in the virtual shopping cart by exercising the commitment of the first user. The processes may further include enabling the first user to share access to the virtual shopping cart with the second user. The virtual shopping cart may be accessible by at least one user other than the first user.

In another embodiment, the processes may further include enabling a third user to enter into a commitment to contribute additional funds toward the purchase, by the second user, of the items contained in the virtual shopping cart. The processes may further include enabling the second user to purchase the items contained in the virtual shopping cart by exercising the commitment of the third user. The processes may further include enabling the first user to compose an electronic message to be transmitted to the second user. The processes may further include enabling the first user to transfer control of the virtual shopping cart to the second user.

According to yet another embodiment, the processes may further include enabling the first user to convert the virtual shopping cart into a curated list of the one or more items contained in the virtual shopping cart. The curated list may be accessible by at least one user other than the first user.

In another embodiment, the processes may further include enabling the first user and/or the second user to enter a comment and/or a rating to be associated with the virtual shopping cart and/or the items contained in the virtual shopping cart. The comment and/or the rating may be viewable by at least one user other than the first user and the second user.

The processes may further include providing, to the first user and/or the second user, information related to the virtual shopping cart. The information related to the virtual shopping cart may include an identity of the first user, a first fund amount representing the commitment of the first user, a second fund amount representing a difference between at least a price of the at least one of the one or more items contained in the virtual shopping cart and the first fund amount, or any combination of information.

According to one embodiment, a method of shopping within an electronic commerce environment includes providing for a first user to select, within a user interface operating on a client computing system connected to an electronic commerce system over a computing network, at least one action from a plurality of actions. The action is to be performed on a virtual shopping cart, and the virtual shopping cart is configured to contain one or more items selected by at least the first user from a plurality of items listed in a database maintained by the electronic commerce system. The method further includes performing, by the electronic commerce system, the action in response to the first user selecting the action from the plurality of actions. The plurality of actions includes: send a virtual shopping cart message to a second user; share access to the virtual shopping cart with the second user; contribute funds toward purchasing at least one of the one or more items contained by the virtual shipping cart; add a comment to the virtual shopping cart; add a comment to at least one of the one or more items; add a rating to the virtual shopping cart; add a rating to at least one of the one or more items; and transfer control of the virtual shopping cart to the second user. The plurality of actions may further include: convert the virtual shopping cart to a curated list of items, and make the virtual shopping cart public.

If the action selected by the first user is send a virtual shopping cart message, performing the at least one action may include transmitting an electronic message to an electronic address associated with the second user. The electronic message may include a virtual link to the virtual shopping cart. The virtual link may be a Hypertext Transfer Protocol (HTTP) request message configured to request access, using a web browser, to the virtual shopping cart through the electronic commerce system.

In another embodiment, if the action selected by the first user is ‘share access to the virtual shopping cart with the second user,’ performing the action may include providing for the second user to view the virtual shopping cart, modify the virtual shopping cart, and/or purchase at least one of the one or more items contained by the virtual shopping cart. If the action selected by the first user is ‘contribute funds toward purchasing at least one of the one or more items contained by the virtual shopping cart,’ performing the action may include enabling the first user to enter into a commitment to contribute funds toward the purchase of the items contained by the virtual shopping cart.

According to one embodiment, a method of shopping within an electronic commerce environment includes enabling a first user of a plurality of users to add an item to a virtual shopping cart using a first user interface that is generated by a server computer system, enabling each of the users to enter into a commitment to contribute funds toward a purchase of the item in the virtual shopping cart using a second user interface that is generated by the server computer system, and causing the item to be purchased if a combination of the funds of the commitments of each of the users is sufficient to purchase the item. The first user may share access to the virtual shopping cart with each of the users. Each of the users may access the virtual shopping cart subsequent to the first user sharing access to the virtual shopping cart with each of the users.

According to one embodiment, a method of shopping within an electronic commerce environment includes enabling a first user of a plurality of users to add one or more items to a virtual shopping cart of the first user that is maintained by a server computer system, generating, by the server computer system, statistical data related to the items, and providing the statistical data to the first user in a web page that is generated by the server computer system. The statistical data includes a total quantity of at least one of the items that are contained in the virtual shopping carts of all of the users.

In another embodiment, the statistical data may include a location of each of the plurality of users having the at least one of the one or more items in their virtual shopping carts. The location may be graphically represented on a map that is generated by the server computer system and presented to the first user in the web page. The statistical data may include a quantity of each of the one or more items which are available for purchase. The statistical data may include a date on which the at least one of one or more items was added to the virtual shopping cart of any of the users.

According to yet another embodiment, a seller of at least one of the items may be enabled to send a sales incentive to the first user. Sending the sales incentive to the first user may consume a pre-determined number of points that are allocated to the seller. The pre-determined number of points may be based on a characteristic of the seller, the first user and/or the statistical data. The characteristic of the first user may include a purchase history of the first user, a location of the first user, a length of time that the first user has been a member of the electronic commerce environment, and/or the one or more items in the virtual shopping cart of the first user. The characteristic of the seller may include a sales volume of the seller within the electronic commerce environment, a sales history of the seller, and/or a length of time that the seller has been a member of the electronic commerce environment. In one embodiment, the sales incentive may include a price discount offer, a shipping cost discount offer, a free item offer, a free shipping offer, a two-for-one offer, and/or a credit offer.

According to one embodiment, an electronic commerce system includes a virtual shopping cart component configured to enable a first user of a plurality of users to add one or more items to a virtual shopping cart of the first user, and a statistical data component. The statistical data component is configured to generate statistical data related to the one or more items, and provide the statistical data to the first user in a web page that is generated by the electronic commerce system. The statistical data includes a total quantity of at least one of the one or more items that are contained in the virtual shopping carts of all of the users. The statistical data may include a location of each of the plurality of users having the at least one of the one or more items in their virtual shopping carts. The location may be graphically represented on a map that is presented to the first user in the web page. The statistical data may include a quantity of each of the one or more items which are available for purchase. The statistical data may include a date on which the at least one of one or more items was added to the virtual shopping cart of any of the plurality of users.

According to another embodiment the statistical data component may be configured to enable a seller of the at least one of the one or more items to send a sales incentive to the first user. Sending the sales incentive to the first user may consume a pre-determined number of points that are allocated to the seller. The pre-determined number of points may be based on a characteristic of the seller, the first user and/or the statistical data. The characteristic of the first user may include a purchase history of the first user, a location of the first user, a length of time that the first user has been a member of the electronic commerce environment, and/or the items in the virtual shopping cart of the first user. The characteristic of the seller may include a sales volume of the seller within the electronic commerce environment, a sales history of the seller, and/or a length of time that the seller has been a member of the electronic commerce environment. The sales incentive may include a price discount offer, a shipping cost discount offer, a free item offer, a free shipping offer, a two-for-one offer, and/or a credit offer.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a block diagram of an e-commerce system in accordance with one embodiment of the present invention;

FIG. 2 illustrates a shopping cart webpage of the e-commerce system of FIG. 1 in accordance with one embodiment of the present invention;

FIG. 3 illustrates a gift recipient webpage of the e-commerce system of FIG. 1 in accordance with another embodiment of the present invention;

FIG. 4 illustrates a shopping cart webpage of the e-commerce system of FIG. 1 in accordance with another embodiment of the present invention;

FIG. 5 illustrates a shipping confirmation webpage of the e-commerce system of FIG. 1 in accordance with another embodiment of the present invention;

FIG. 6 illustrates a contribution configuration webpage of the e-commerce system of FIG. 1 in accordance with another embodiment of the present invention;

FIG. 7 illustrates a contribution submission webpage of the e-commerce system of FIG. 1 in accordance with another embodiment of the present invention; and

FIG. 8 illustrates a flow diagram for a process of shopping within the electronic commerce environment in accordance with one embodiment of the present invention.

### DETAILED DESCRIPTION OF THE INVENTION

Embodiments of the invention are not limited in their application to the details of construction and the arrangement of components set forth in the following description or illustrated in the drawings. Embodiments of the invention are capable of other embodiments and of being practiced or carried out in various ways. Also, the phraseology and terminology used herein is for the purpose of description and should not be regarded as limiting. The use of “including,” “comprising,” “having,” “containing,” “involving,” and variations thereof herein is meant to encompass the items listed thereafter and equivalents thereof as well as additional items.

Embodiments of the present disclosure provide systems and methods for shopping within an e-commerce environment that is provided by an e-commerce platform. In one embodiment, the e-commerce environment supports an online marketplace where goods, services, and other articles of commerce can be bought and sold over the Internet or other computer networks, such as through websites designed for these purposes. The goods and services may be physical and tangible, or virtual (e.g., privileges for accessing restricted content on a website, discount offers, or other non-physical goods).

The e-commerce platform may be tailored to serve particular purposes, such as business-to-business commerce (e.g., wholesale), business-to-consumer commerce (e.g., on-line retail), private sales, auctions, or individual store fronts, and may even be further specialized to support a particular marketplace (e.g., for clothing, housewares, artwork, and so forth). The e-commerce platform may also provide features that facilitate activity within the marketplace, such as search engines, social media (e.g., on-line forums, blogs, social networks, shared photo and video albums, wilds, netmeetings, and virtual entertainment), financing and payment tools (e.g., banking, fund transfer, credit services), shipping and freight services, and so forth. For example, the e-commerce platform may provide a tool that automatically identifies, to a user, one or more other users who may be interested in an item being viewed by the user on the e-commerce website. For example, if the user is viewing an item, the website may provide an interface that enables the user to select one or more people with whom the user has a relationship (e.g., friends, family, and so forth) as prospective recipients of the item. Further, the item may be purchased by the user, or a combination of users, as a gift for the prospective recipient. In this manner, the e-commerce environment provides users with new and unique tools for online shopping. The e-commerce platform may be backed by so-called “brick-and-mortar” facilities, such as retail stores, distribution warehouses, and the like. In another example, the platform may merely be an electronic facilitator of trading markets between independent individuals and businesses.

### Shopping Based on Relationships, Materials, Techniques, and Tools

According to one aspect of the present invention, an e-commerce website, which is supported by the e-commerce platform, hosts listings for large numbers of saleable items. It should be understood that, as used herein, an “item” refers to a good, a service, an article of commerce, or any combination thereof. According to various embodiments of the invention, the systems and methods disclosed herein provide virtual shopping carts and other tools for selecting and purchasing items listed at the e-commerce website. In other embodiments, virtual shopping carts and tools may be used to purchase items that are sold or traded through channels other than the website, such as another e-commerce website, classified advertisements, a physical store, or an auction, among others.

In one implementation, a user of a conventional e-commerce website may browse item listings online and select one or more of those items, which are then placed into a conventional virtual shopping cart on the website. Once items are added to the cart, the user may choose to purchase the items for himself, or for another person (e.g., as a gift). At the user's request, the merchant may ship the items to a recipient using shipping information provided by the user.

In one conventional method, the user must supply shipping information for the recipient (e.g., name and shipping address) either before placing an order or during the ordering process so that the merchant may ship the item directly to a recipient other than the user. The merchant may allow the user to save the shipping information in a virtual address book or other database on a conventional e-commerce website. However, unless the recipient's shipping information is provided by the user, there is no other relationship known to the merchant by which the merchant can associate the recipient with the user.

According to one embodiment of the present invention, it is appreciated that an online shopping process may provide a user with information about other people with whom the user has a relationship or other association. Such relationships may include friends, family members, colleagues, business associates, buyers and sellers, or relationships based on other social commitments. Relationships may also be based on other characteristics, such as people who purchase similar items, items fabricated using similar techniques, tools or materials, people who live or work in similar geographic locations, and people in similar age (or other demographic) groups. In one aspect, such relationships may be conceptually classified as a series of concentric circles, the center at which sits the user himself. Each concentric circle around the user may include one or more people with whom the user has a relationship, for example, a relationship of a particular degree (e.g., near, far). Circles closer to the center may represent stronger or closer relationships (such as a spouse, children, parents, siblings), while circles farther away from the center may represent weaker or more distant relationships (co-workers, people the user has purchased items from, people who have purchased items from the user, people who designed something that was purchased by the user, among others).

Concentric circles, according to one embodiment, enable the user to leverage various relationships within the context of an e-commerce environment. In one example, the relationships may be used to suggest gift recipients based on an item selected by the user within the e-commerce website. In another example, the relationships may be used to suggest gifts based on characteristics of the related person, such as the person's shopping history or the person's favorite items.

In one embodiment, the relationship is defined as one or more characteristics associated with the user of the e-commerce website. The characteristic may, for example, be stored as a parameter associated with the user in a database that is maintained by, or accessible by, the e-commerce website. For example, a parameter may be assigned to each user containing information about the relationship, such as what type of relationship exists (e.g., friend, family, seller, buyer, and so forth). The parameter may contain data related to the characteristic, such as a username, an e-mail address, a real name, a search query, contents of an e-mail, a social network posting, or any other identifying information that may be used to characterize the relationship and that may be collected electronically, either through the e-commerce website or through another electronic data source (e.g., accessible through the Internet).

For example, relationship information may be gathered through the e-commerce website using a user profile feature. The user may configure his or her profile to include the names of other users with whom the user has a relationship. Further, the user may characterize the relationship (e.g., family, friend, buyer, seller, and so forth), or the system may automatically characterize the relationship based on user behavior (e.g., creating relationships with anyone that the user sells an item to, buys an item from, buys an item for, receives an item from, sends or receives an electronic message to or from, and so forth).

In one embodiment, a virtual shopping cart (also referred to herein as shopping cart or cart) may be created in response to a user selecting one or more items listed for sale on the e-commerce website for prospective purchase. The e-commerce platform includes software that stores the selected items in the cart (e.g., within a database on a server) for an indefinite period of time. For example, the items may be stored in the cart until the user removes them from the cart or completes an order to purchase them. According to one embodiment, the virtual shopping cart may exist independently of an interactive user session at the website (e.g., stored in a database) such that the items remain the cart after the user exits, or logs out of, the website. This allows the user who created the cart to return at a later time and review the contents of the cart, add items to or remove items from the cart, or purchase any of the items in the cart. Further, the e-commerce website may permit other users to review and/or modify the contents of the cart.

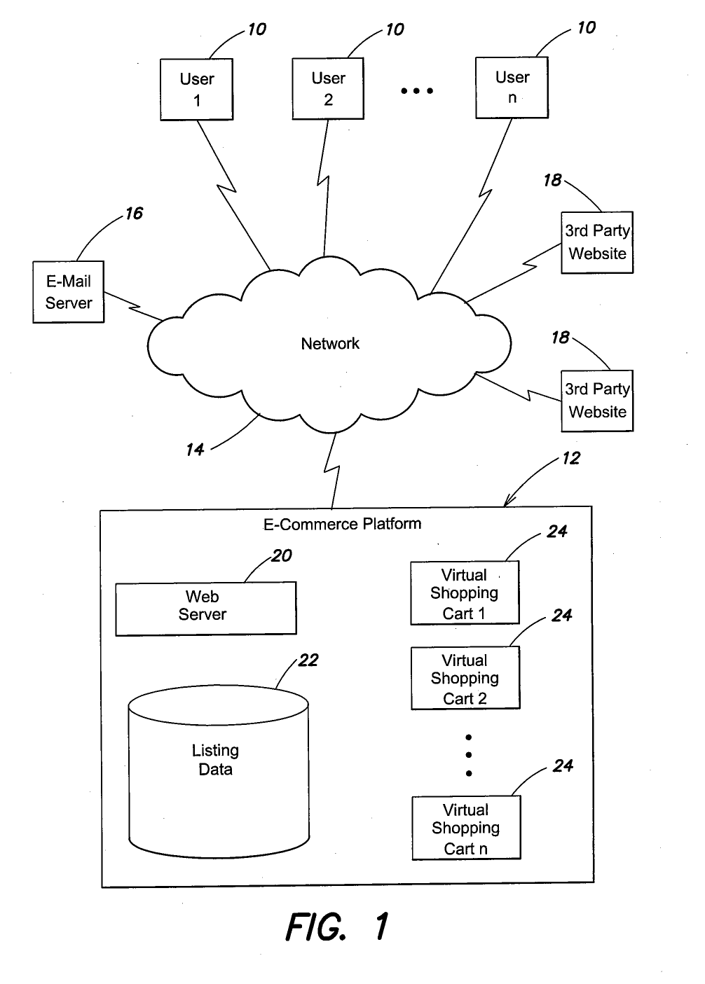

FIG. 1 illustrates a block diagram of an e-commerce system in accordance with one embodiment of the present invention. One or more users 10, each using a client computing system (not shown), connect with an e-commerce platform 12 through a network 14, such as the Internet or other wide area network. One or more e-mail servers 16, third party websites 18, or combinations of these may, optionally, connect with e-commerce platform 12. E-commerce platform 12 includes a web server 20 and a listing database 22, and is configured to maintain one or more virtual shopping carts 24. Listing database 22 may include, among other things, listing data associated with each of a plurality of items listed within the e-commerce system. For example, the listing data may include a name or title for each item that is listed for sale, a description of the item (or other visual representation), information about purchasing the item, and other information. Each user 10, who may be, for example, a buyer, seller, or other individual or entity, uses the client computing system to interact with e-commerce platform 12.

As will be described in further detail below, each virtual shopping cart 24 represents a collection of one or more items that are selected by each user 10 from the list of items for prospective purchase. Virtual shopping cart 24, and the items contained therein, are accessible by user 10 who initially selected the items. User 10 may view the contents of virtual shopping cart 24 and/or modify the contents by adding or removing items. User 10 may also share access to virtual shopping cart 24 with one or more other users. A user having shared access to virtual shopping cart 24 may be assigned privileges associated with the cart, such as the ability to view the contents of the cart, add comments to the cart, add or remove items from the cart, purchase one or more items in the cart, or any combination thereof. Items in each cart 24 are not purchased until user 10, or another user having shared access and purchase privileges, completes a checkout process, at which time the purchased items are removed from the cart.

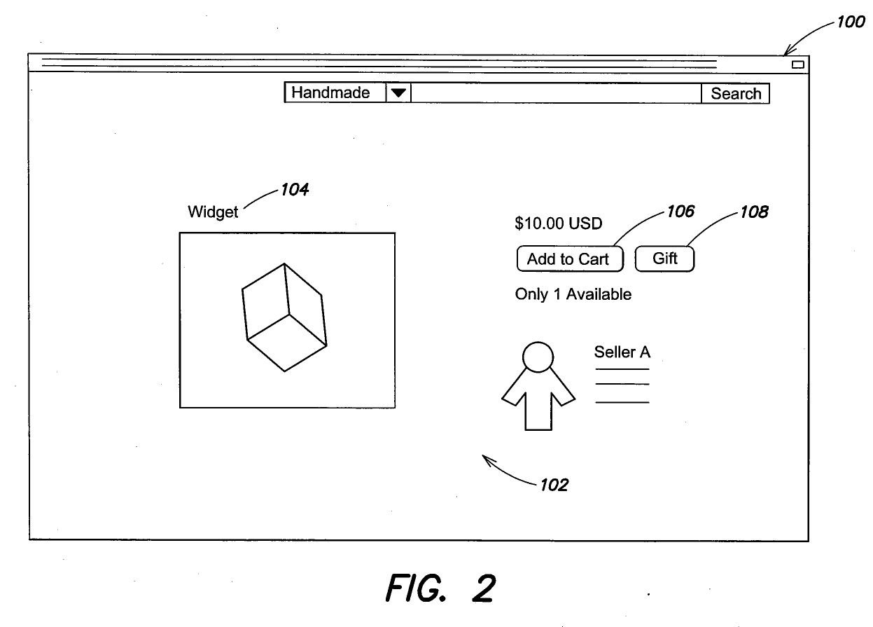

FIG. 2 illustrates a shopping cart webpage 100 for displaying a virtual shopping cart, an exemplary representation of which is generally indicated at 102, in accordance with one embodiment. Virtual shopping cart webpage 100 may be generated by web server 20 of the e-commerce platform 12, as described above with respect to FIG. 1, and displayed by a web browser software application executing on, for example, a personal computer (not shown) of user 10. Webpage 100 includes data that is communicated between web server 20 and the web browser application over network 14. Examples of web browser applications include the well-known Microsoft EXPLORER® browser application available from Microsoft Corporation of Redmond, Wash., and Google Chrome from Google, Inc. of Mountain View, Calif.

Virtual shopping cart 102 includes one or more items 104 that have been selected by a user for prospective purchase, for example, from an inventory or listing of items for sale as displayed at the e-commerce website. The contents of virtual shopping cart 102, including, but not limited to, information about the selected items 104, is displayed within webpage 100. Shopping cart webpage 100 may optionally contain additional information related to the items 104, such as quantity, price, availability, shipping costs, total price, information about the seller, and/or other relevant information. Shopping cart webpage 100 further includes an Add to Cart button 106 and a Gift button 108.

A user may use shopping cart webpage to select and purchase item 104 using, for example, the Add to Cart button 106 or other suitable interface control. Alternatively, the user may use the Gift button 108 to initiate a process of purchasing item 104, or contributing funds toward a purchase of the item, for another person (also referred to herein as a gift recipient, or merely recipient), rather than purchasing the item for themselves.

It is appreciated, according to one embodiment, that the user may not have any particular gift recipient in mind while the user is shopping. For example, the user may be browsing the e-commerce website and happen upon an item of interest, thinking that it might make a nice gift for someone else. However, the user may be unsure of whom to give the item to. Therefore, according to one embodiment, one or more gift recipients may be suggested to the user. The gift recipients are selected by a software component of the e-commerce platform which searches a user database containing information about various users of e-commerce platform 12. Such information may include, but is not limited to, the identities of the various users and any relationships that are known (e.g., the relationships include family members, friends, sellers, or buyers, among others). In one embodiment, the software component includes an algorithm that generates a list of the gift recipients based on relationships between the user and each of the suggested recipients. The relationships may, alternatively, be based on characteristics of the item (e.g., item description, color, material, size, category), or other factors. Relationship data may be stored in a database of e-commerce platform 12 and accessed by web server 20.

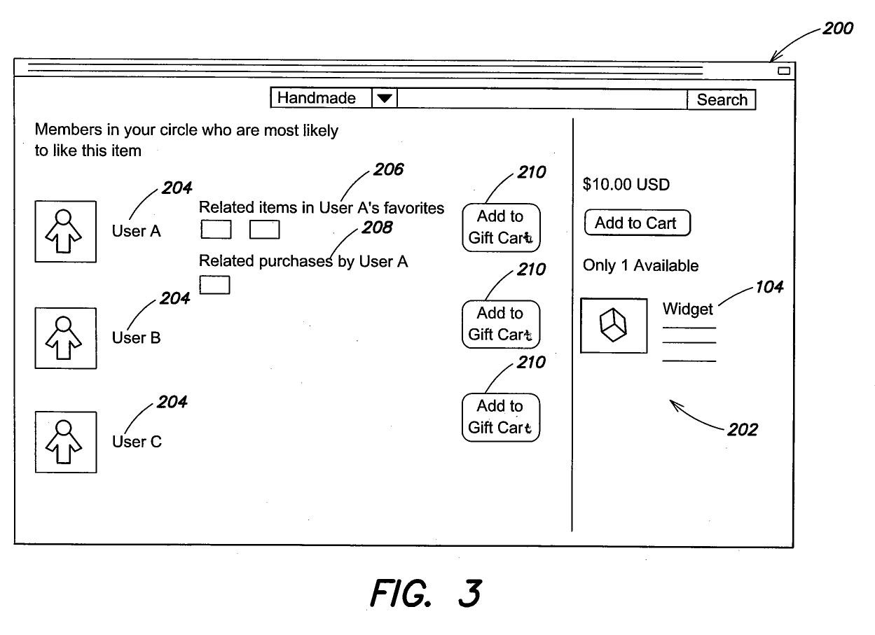

FIG. 3 illustrates a gift recipient webpage 200 for displaying the list of suggested gift recipients in accordance with one embodiment. Webpage 200 includes information related to item 104, which was previously selected by the user, such as price and availability. Webpage 200 further includes a list of one or more suggested recipients, each indicated at 204. Each suggested recipient may represent a person or other entity for which the user may purchase item 104 or contribute funds toward the purchase of the item. Optionally, additional information related to each suggested recipient 204 may be displayed. The information related to item 104 and the additional information may be stored, for example, in listing database 22 and accessed by web server 20. Webpage 200 further includes at least one Add to Gift Cart button 210 associated with a respective suggested recipient 204.

In one example, the additional information may include one or more related items 206 that are related to item 104 (e.g., related by type, style, price, color, material, texture, use, function, name, product category, among others) and that have been identified by the respective suggested recipient 204 as a “favorite.” Such additional information may be stored, for example, in a database of e-commerce platform 12 and accessed by web server 20. Information about related items 206 may be useful to the user because the information provides insight to the tastes and interests of the suggested recipient 204. The user may, in turn, use the information about related items 206 to decide whether item 104 would be a suitable gift for the suggested recipient 204.

In another example, the additional information may include one or more purchased items 208 that are related to item 104 and have been purchased by the respective suggested recipient 204. Information about purchased items 208 may be useful to the user because the information provides insight to the tastes and interests of the suggested recipient 204. The user may, in turn, use the information to decide whether item 104 would be a suitable gift for the suggested recipient 204. For example, if one of the purchased items 208 is similar to item 104, the user may decide that item 104 would not be a suitable gift. On the other hand, if one of the purchased items 208 is complementary to item 104, the user may decide that item 104 would be an appropriate gift. Therefore, the additional information enables the user to make informed purchasing decisions.

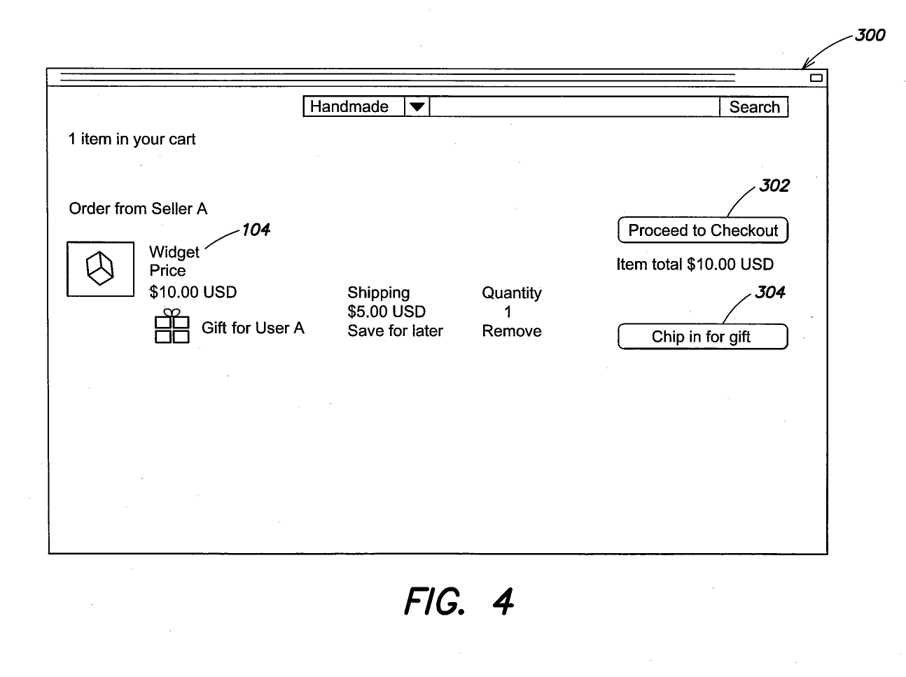

According to one embodiment, the user may select Add to Gift Cart button 210 corresponding to User A 204 if the user wishes to place item 104 into a gift cart to prospectively purchase the item for User A. Pressing Add to Gift Cart button 210 initiates a purchase or contribution process that enables the user to purchase item 104 for User A, or to contribute funds toward the purchase of item 104 for User A. In one embodiment, the process includes creating an instance of virtual shopping cart 24 for containing the item 104. The process may further include enabling one or more users to view virtual shopping cart 24 and, optionally, purchase the item 104 in the cart or contribute funds toward the purchase of the item, such as described below with respect to FIG. 4.

FIG. 4 illustrates a shopping cart webpage 300 for displaying a virtual shopping cart in accordance with another embodiment. After placing item 104 into the gift cart, such as by using Add to Gift Cart button 210 described above with respect to FIG. 3, webpage 300 is displayed to the user. Webpage 300 includes a Proceed to Checkout button 302 and a Chip In for Gift button 304. Proceed to Checkout button 302 enables the user to purchase item 302 as a gift for another person (e.g., User A) by paying the entire purchase price of the item. Chip in for Gift button 304 enables the user, alternatively, to contribute funds toward the purchase of item 302. The contributed funds may be less than the entire purchase price (e.g., a portion of the purchase price). While the user commits to paying the portion of the purchase price that he committed to, item 104 is not purchased until either the user or a combination of users collectively contribute funds sufficient to purchase the item (i.e., at least enough to cover the purchase price).

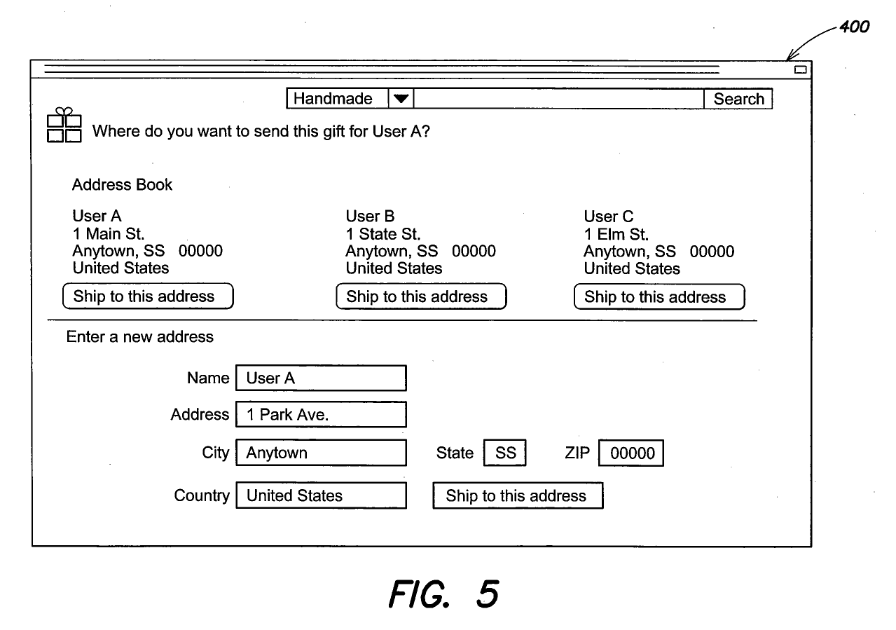

FIG. 5 illustrates a shipping configuration webpage 400 for entering and displaying shipping information in accordance with one embodiment. After the user presses the Chip In for Gift button 304, as described above with reference to FIG. 4, or after the user presses the

Proceed to Checkout button 302, the user is prompted to provide shipping information for shipping item 104 to the recipient subsequent to the purchase of the item (either as a full purchase by the user or as a purchase using contributions from one or more users). The shipping information includes, but is not limited to, a name and address of the recipient, who may be one of the suggested recipients 204 or another person (including the user himself).

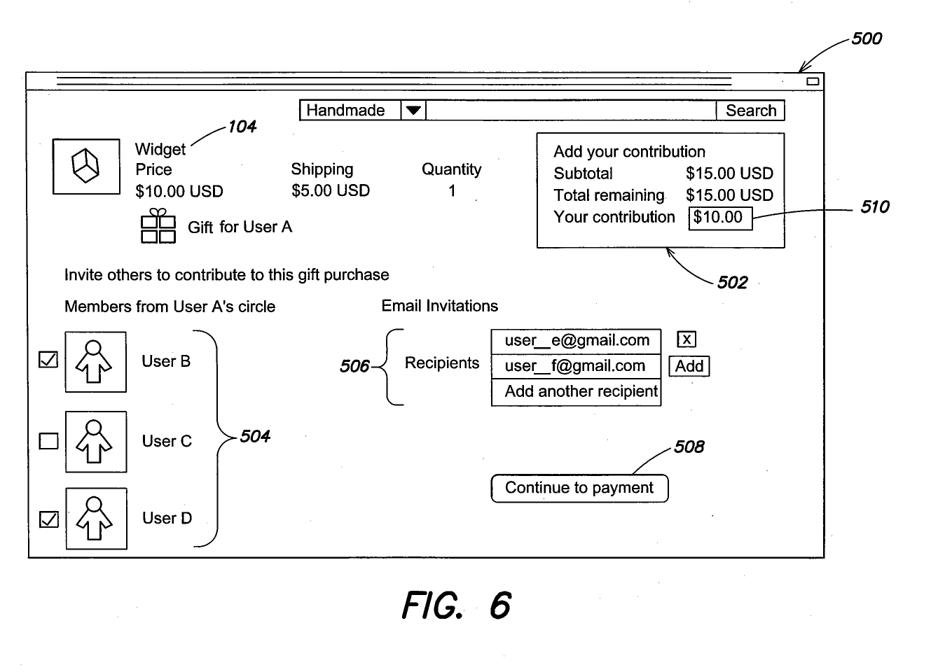

FIG. 6 illustrates a contribution configuration webpage 500 for configuring a fund contribution according to one embodiment. Included on webpage 500 is information about item 104, a contribution status 502, a list of users 504, a list of invited recipients 506, and a Continue to Payment button 508. Webpage 500 enables the user to enter a contribution amount 510, which is an amount of funds the user commits toward the purchase of item 104. Contribution status 502 includes other information, such as a subtotal amount for the purchase and a total amount remaining for the purchase. For example, if the subtotal amount is $15.00, and $5.00 in contributions toward the purchase of item 104 have been received by the e-commerce website, the total amount remaining will be $10.00. The subtotal amount and total amount remaining may be calculated by an application component of e-commerce platform 12. The total amount remaining may not be updated until after each contribution has been received, or it may be updated in real-time to reflect the effect of entering contribution amount 510 by the user.

Contribution amount 510 may be any amount including the subtotal amount or the total amount remaining, and is chosen at the discretion of the user.

In addition to enabling the user to enter contribution amount 510, webpage 500 enables the user to invite one or more other people to contribute toward the purchase of item 104. In one example, a list of other users of the e-commerce website 504 may be displayed on webpage 500. The other users may be the suggested users 204, as described above with reference to FIG. 3, or other users. The list of other users 504 may provide selection boxes (such as the checkboxes shown in FIG. 6) to enable the user to invite any or all of the users from list 504. Invited users may be sent, for example, an e-mail message or other communication that is generated by the e-commerce website. The e-mail or other communication may include information about item 104, the designated recipient of item 104, the cost of item 104, the total remaining amount for item 104, or other information which will assist the invited user(s) with reviewing the invitation and possibly submitting further contributions toward the purchase of item 104.

In one embodiment, the e-mail message may include a link, such as a Hypertext Transfer Protocol (HTTP) address that points to a webpage containing the gift cart or item 104. The link may be generated automatically by the e-commerce platform. When the recipient of the e-mail message clicks on the link, the gift cart is displayed to the recipient within a webpage. The e-mail message may also include one or more other elements, such as the message subject and the message body (e.g., the contents of the message).

In another example, a list of e-mail addresses 506 of invited users may be displayed on webpage 500. The list of e-mail addresses 506 may be manually populated or automatically populated (e.g., using an electronic address book accessible through the e-commerce website) based on the selected other users in list 504. The user may also, or alternatively, supply one or more e-mail addresses of other invited users. As described above, invited users may be sent an e-mail or other communication that is generated by the e-commerce website which enables the invited users to view information about item 104 and submit further contributions toward the purchase of the item.

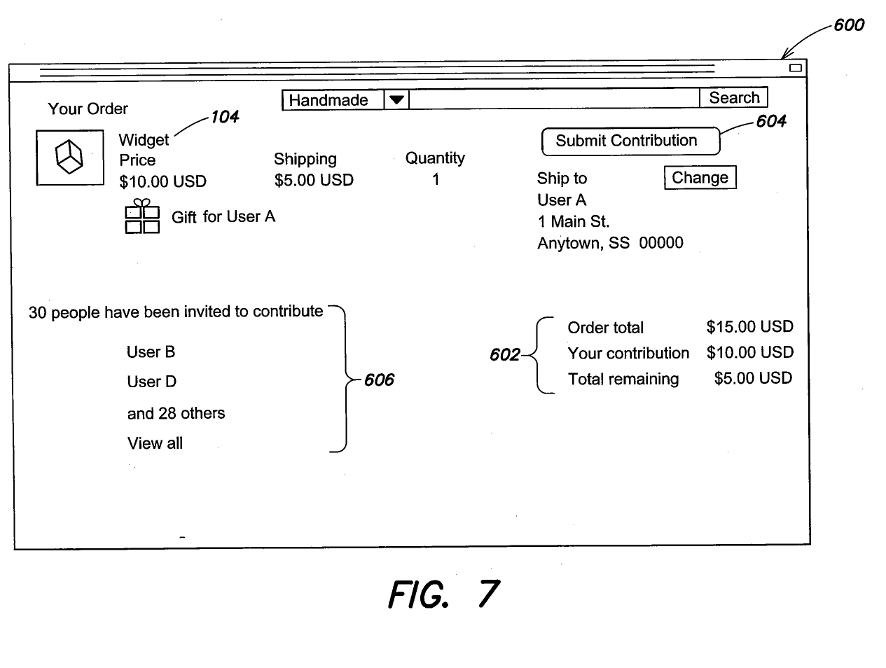

Once the user has supplied contribution amount 510, selecting Continue to Payment 508 button will enable the user to submit payment for the contribution amount, as will be described below with reference to FIG. 7. If contribution amount is at least the same as the total amount remaining, it is not necessary to solicit further contributions toward the purchase of item 104, and the item may be purchased immediately.

FIG. 7 illustrates a contribution submission webpage 600 for submitting the contribution amount previously entered by the user using, for example, webpage 500 as described above with reference to FIG. 6. Webpage 600 includes information about item 104, order information, which is generally indicated at 602, a Submit Contribution button 604, and invitee information, which is generally indicated at 606. Order information 602 includes an order total, a contribution amount, and a total amount remaining (e.g., the difference between the order total and the contribution amount). Selecting Submit Contribution button 604 causes the e-commerce website to process the contribution (e.g., charges the user for the contribution amount). Invitee information 606 may be configured to display information about other users who have been invited to contribute funds toward the purchase of item 104, such as a list of invited users.

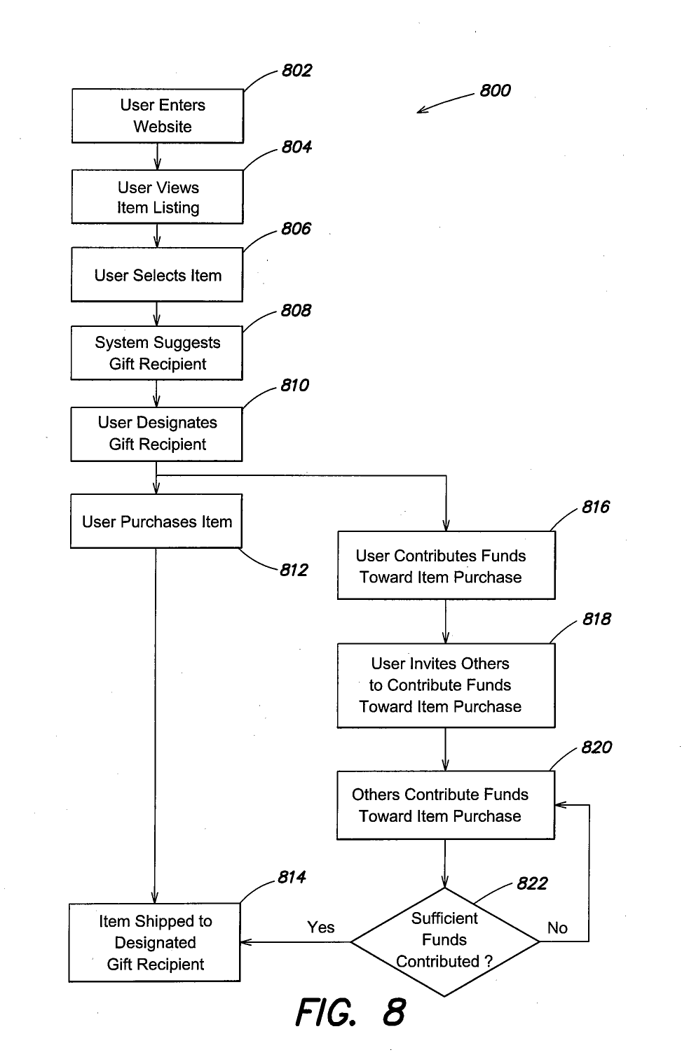

FIG. 8 illustrates a process 800 for shopping within an electronic commerce system according to one embodiment. Process 800 begins at block 802 where a user enters the e-commerce website. At block 804, the user views an item listing that shows a representation of the item, which is stored, for example, in the listing database 22 of e-commerce platform 12. The listing may include information about the item, such as a description of the item, a price of the item, a photograph or illustration of the item, a shipping cost of the item, a quantity available of the item, and other relevant information.

At block 806, the user may, optionally, select the item. The selected item is placed by the system into a virtual shopping cart for further processing. In response to the user's selection, the system suggests one or more gift recipients at block 808. In one embodiment, the system searches a database of other users having a relationship with the user, such as a relative of the user, a friend of the user, or other kind of relationship, and generates a list of suggested gift recipients. The list may be displayed to the user using, for example, webpage 200, as described above with respect to FIG. 3. In one example, the list includes other users having particular relationships with the user, such as one or more siblings, parents, friends, business associates, etc. The list may be ranked or sorted according to a degree of strength of the relationship (e.g., family is stronger/closer than friends or business associates). In another example, the suggested gift recipients may include other users who may have an interest in the selected item. Such interest may be determined by the e-commerce platform in a number of ways, including, but not limited to, a purchase history of the other user (e.g., the other user has purchased other items that are similar to the selected item in description, color, material, category, or other characteristic) or items that the other user has indicated are “favorites.” It should be appreciated that other characteristics of the selected item or user relationship may be utilized alone or in combination when searching the database for suggested gift recipients.

At block 810, the user may, optionally, select from the list of suggested gift recipients a designated gift recipient. In response to selecting the designated gift recipient, the system enables the user to enter a purchasing process wherein the item may be purchased on behalf of the designated gift recipient. The designated gift recipient is a person or entity that will receive the item after it is purchased by the user, or by several users in combination through fund contributions. For example, if the user purchases the item outright (e.g., pays the total purchase price of the item), the item is purchased at block 812 and shipped (e.g., by the seller) to the designated gift recipient at an address supplied to the e-commerce platform by the user, and process 800 ends.

Alternatively, if the user chooses to contribute funds toward the purchase of the item (e.g., pays less than the total purchase price of the item) at block 816, the item will not be purchased or shipped to the designated gift recipient at least until sufficient funds have been contributed to cover the total purchase price. In response to receiving a contribution, the system stores the contributed amount (e.g., in a database) and may, optionally, display, to one or more users through a webpage, the total contributed amounts and/or the amount remaining to complete the item purchase. At block 818, the user may, optionally, invite one or more other users to contribute funds toward the purchase of the item. Such invitations may take various forms, such as e-mail messages, instant messages, or other forms of electronic communication that include information about the item, such as an HTML link to the virtual shopping cart containing the item that the invitee may select to view the item. At block 820, any of the invited users may, optionally, contribute funds toward the purchase of the item. In this manner, multiple people may each pay for a portion of the total purchase price of the item. At block 822, all of the contributed funds are totaled by the system. If the total of the contributed funds is sufficient to purchase the item, then the item is purchased, and subsequently shipped to the designated gift recipient at block 814. If the contributed funds are insufficient, then process 800 returns to block 820, where other users may further contribute funds. In another embodiment, any of the invited users may, optionally, further invite other users to contribute funds toward the purchase of the item.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the scope of the invention. For example, a list of suggested recipients may be generated based on relationships including family, friends, relatives, business associates, among others. The list of suggested recipients may, alternatively, be generated based on attributes of the suggested recipients (e.g., age, gender, location, purchasing history, browsing history, favorite items, among others), or based on attributes of the item(s) selected by the user, such as materials, construction techniques, or manufacturing tools. For example, the suggested recipients may includes people who build furniture using handsaws in Brooklyn, N.Y.

In another example, one aspect of the invention provides users of the e-commerce website with the ability to create a virtual shopping cart containing one or more items, and to share access to the cart with one or more other users. Users having access to the shared cart may purchase items in the cart or contribute funds toward the purchase of the items (e.g., a “shared” purchase). Items in the shared cart may be modified (e.g., quantity, color, material, shipping address, among other item characteristics) or removed from the cart by one or more users. For example, a first user may contribute funds toward a portion of the total cost of an item in the cart, and a second user may contribute additional funds towards the remaining amount. The item is purchased once enough funds have been contributed, by any number of users, to cover to total cost.

In yet another example, according to one embodiment, the e-commerce platform provides, to one or more users, information related to the virtual shopping carts of one or more users. The information includes statistical data associated with any of the items contained by the virtual shopping carts, such as a quantity of a particular item available for sale, a number of unique shopping carts containing the particular item, identifying information of the user or users having the particular item in their carts, or any combination of these data.

Accordingly, the foregoing description and drawings are by way of example only.

What is claimed is:

1. A method of shopping within an electronic commerce environment, the method comprising acts of:
providing first, second and third user interfaces generated by a server computer system;
enabling a user of an electronic commerce website to select an item for sale using the first user interface;
providing, to the user, a suggestion for a recipient for the selected item based on a relationship between the user and the suggested recipient, the relationship to be identified using characterization information associated with the user and stored in a database on the server computer system;
enabling the user to designate the suggested recipient as a prospective recipient of the selected item using the second user interface; and
enabling the user to contribute funds toward a purchase of the selected item using the third user interface wherein the selected item is to be shipped to the prospective recipient subsequent to the purchase.

2. The method of claim 2, further comprising an act of enabling the user to invite at least one other user to contribute funds toward the purchase of the selected item using a fourth user interface to be provided by the server computer system.

3. The method of claim 2, further comprising an act of sending a message to the at least one other user for inviting the at least one other user to contribute funds toward the purchase of the selected item using a fourth user interface to be provided by the server computer system.

4. The method of claim 2, further comprising an act of enabling the at least one other user to contribute funds toward the purchase of the selected item using a fourth user interface to be provided by the server computer system.

5. The method of claim 4, wherein the purchase occurs when a total of the contributed funds is sufficient to purchase the selected item.

6. The method of claim 2, further comprising an act of enabling the at least one other user to invite at least one additional user to contribute funds toward the purchase of the selected item using a fourth user interface to be provided by the server computer system.

7. The method of claim 6, further comprising an act of enabling the at least one additional user to contribute funds toward the purchase of the selected item using a fourth user interface to be provided by the server computer system.

8. The method of claim 1, wherein the suggested recipient is a family member of the user.

9. The method of claim 1, wherein the suggested recipient is a friend of the user.

10. The method of claim 1, wherein the suggested recipient is a friend-of-a-friend of the user.

11. The method of claim 1, wherein the suggested recipient is a person from whom the user has previously purchased a commodity.

12. The method of claim 1, wherein the suggested recipient is a person to whom the user has previously sold a commodity.

13. The method of claim 1, wherein the suggested recipient is a person who designed a commodity purchased by the user.

14. The method of claim 1, wherein the suggested recipient is a person who purchased a commodity designed by the user.

15. The method of claim 1, wherein the act of suggesting further comprises determining a confidence level associated with the suggested recipient based on a characteristic of the suggested recipient, and wherein the act of suggesting is further based on the confidence level.

16. The method of claim 15, wherein the characteristic of the suggested recipient includes at least one of favorite items of the suggested recipient and items purchased by the suggested recipient.

17. The method of claim 15, wherein the act of suggesting further comprises an act of ranking the suggested recipient based on the confidence level.

18. The method of claim 1, wherein the act of suggesting further comprises an act of ranking the suggested recipient based on the relationship.

19. The method of claim 18, wherein a ranking of the suggested recipient corresponds to a degree of separation between the user and the suggested recipient, wherein the degree of separation accords to one of a familial relationship, a friendship, and an indirect relationship.

20. An electronic commerce system, comprising:
a virtual shopping cart component configured to enable a user to select an item for sale using a first user interface to be provided by a server computer system; and
a recipient configuration component configured to:
suggest, to the user, a recipient for the selected item based on a relationship between the user and the suggested recipient, the relationship to be identified using characterization information associated with the user and stored in a database to be provided by the server computer system;
enable the user to designate the suggested recipient as a prospective recipient of the selected item using a second user interface to be provided by the server computer system; and
enable the user to contribute funds toward a purchase of the selected item using a third user interface to be provided by the server computer system;
wherein the selected item is to be shipped to the prospective recipient subsequent to the purchase.

21. The system of claim 20, wherein the recipient configuration component is further configured to enable the user to invite at least one other user to contribute funds toward the purchase of the selected item using a fourth user interface to be provided by the server computer system.

22. The system of claim 21, wherein the recipient configuration component is further configured to send a message to the at least one other user for inviting the at least one other user to contribute funds toward the purchase of the selected item using a fourth user interface to be provided by the server computer system.

23. The system of claim 21, wherein the recipient configuration component is further configured to enable the at least one other user to contribute funds toward the purchase of the selected item using a fourth user interface to be provided by the server computer system.

24. The system of claim 23, wherein the purchase occurs when a total of the contributed funds is sufficient to purchase the selected item.

25. The system of claim 21, wherein the recipient configuration component is further configured to enable the at least one other user to invite at least one additional user to contribute funds toward the purchase of the selected item.

26. The system of claim 25, wherein the recipient configuration component is further configured to enable the at least one additional user to contribute funds toward the purchase of the selected item using a fourth user interface to be provided by the server computer system.

27. A computer readable readable medium having computer-executable instructions stored thereon for shopping within an electronic commerce website, the computer-executable instructions when executed by a computer causing the computer to perform a method comprising acts of:
enabling a user of an electronic commerce website to select an item for sale using a first user interface to be provided by a server computer system;
suggesting, to the user, a recipient for the selected item based on a relationship between the user and the suggested recipient, the relationship to be identified using characterization information associated with the user and stored in a database to be provided by the server computer system;
enabling the user to designate the suggested recipient as a prospective recipient of the selected item using a second user interface to be provided by the server computer system; and
enabling the user to contribute funds toward a purchase of the selected item using a third user interface to be provided by the server computer system;
wherein the selected item is to be shipped to the prospective recipient subsequent to the purchase.

28. The computer readable medium of claim 27, wherein the method further comprises acts of:
generating, by the server computer system, statistical data related to the item, the statistical data including a total quantity of the item that is contained in a plurality of virtual shopping carts of a plurality of users; and
providing the statistical data to the first user in a fourth user interface to be provided by the server computer system.
